(19) United States
(12) Patent Application Publication
(10) Pub. No.: US 2009/0010197 A1
(43) Pub. Date: Jan. 8, 2009

(54) METHOD AND SYSTEM FOR MANAGING MULTIPLE AERIALS IN A WIRELESS SYSTEM

(75) Inventors: Steve Y. Chao, Shanghai (CN); Mao Jun Shen, Rui Chang City (CN); Quan Ge, Shanghai (CN)

Correspondence Address: GENE I. SU, XIN YI RD., SECTION 4, NO. 151, 17F-1, TAIPEI, TW

(73) Assignee: PIOCO MEDIA LIMITED (HONG KONG), Shanghai (CN)

(21) Appl. No.: 12/168,074

(22) Filed: Jul. 4, 2008

Related U.S. Application Data
(60) Provisional application No. 60/947,986, filed on Jul. 5, 2007.

(51) Int. Cl. H04H 20/71

(52) U.S. Cl. 370/312

(57) ABSTRACT

A method and system for managing multiple aerials in a wireless system are described. Specifically, one embodiment of the present invention sets forth a method, which includes the steps of obtaining a first unique ID of a first device within a coverage range, associating a first priority level to the first unique ID, and storing the first unique ID in a first queue associated with the first priority level in a first process, and transmitting data to the first device with the first unique ID in a sequence based on at least the first priority level in a second process. The first process and the second process are independently performed.

### CROSS-REFERENCE TO RELATED APPLICATIONS

This application claims the benefit of the U.S. Provisional Application No. 60/947,986, filed on Jul. 5, 2007 and having Atty. Docket No. 109-0001-US-PRO. This related application is hereby incorporated by reference in its entirety.

### BACKGROUND OF THE INVENTION

1. Field of the Invention

Embodiments of the present invention relate generally to broadcasting and wireless technologies and more specifically to a system and method for controlling multiple aerials in a wireless system.

2. Description of the Related Art

In recent years, many short-range wireless technologies have emerged, such as Bluetooth, Infrared Data Association (IrDA), Home RF, and Wi-Fi based on the IEEE 802.11 standard. These technologies make possible for devices such as mobile phones, laptop computers, and Personal Digital Assistants (PDAs), to connect rapidly and automatically.

In one application, a system utilizing these wireless technologies is configured to push advertisements in various data formats, such as welcome messages, product information, and special offers, to devices that are within a pre-determined range of the system. FIG. 1 is a flow chart illustrating the method steps for a conventional system to broadcast advertising content. Before distributing any advertising content, the conventional system first scans for and identifies any device that is present within its pre-determined coverage range in step 102. After all the devices within the coverage range have been identified, a scanned device list is generated. The system then randomly selects a device from the scanned device list in step 104 and transmits advertising content to the selected device in step 106. After the completion of the transmission, the selected device is deleted from the scanned device list in step 108, and the process restarts from step 102.

The aforementioned method steps have several short comings. For example, if there are many devices present in the pre-determined range, the conventional system often wastes much time scanning for and identifying all the devices in step 102. The conventional system also needs to complete the scanning step before the transmission of advertising content to the devices in step 104 can take place. In other words, if step 102 is not completed, the conventional system is unable to proceed to step 104. Under certain circumstances, the system may even be trapped in an infinite loop of scanning for available devices.

Moreover, the conventional system also lacks an effective mechanism to track the history of what advertising content has been sent to which device. As a result, the same advertising content may be repeatedly delivered to the same device. Such repeated distribution of the same advertising content unnecessarily consumes valuable resources of the system and likely reduces the effectiveness of the advertising campaign.

Still another shortcoming of the convention system is related to the handling of unsuccessful transmissions. In particular, when the transmission of the advertising content to a device fails, the conventional system continues to try until the device receives the advertising content. If the transmission continues to fail, the system may again be trapped in an undesirable loop of trying to transmit to the same failing device while ignoring other available devices. The valuable resources of the system, as a result, are wasted on the repeated attempts to rectify the transmission failures.

As the foregoing illustrates, what is needed is a method and system to manage multiple aerials in a wireless system so that the advertising content can be effectively distributed and at least the problems set forth above are addressed.

### SUMMARY OF THE INVENTION

A method and system for managing multiple aerials in a wireless system are described. Specifically, one embodiment of the present invention sets forth a method, which includes the steps of obtaining a first unique ID of a first device within a coverage range, associating a first priority level to the first unique ID, and storing the first unique ID in a first queue associated with the first priority level in a first process, and transmitting data to the first device with the first unique ID in a sequence based on at least the first priority level in a second process. The first process and the second process are independently performed.

At least one advantage of the present invention is the ability to support two independent processes, one of which is to identify a wireless device within a coverage range, and another of which is to transmit data to a wireless device identified within the coverage range.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a flow chart illustrating the method steps for a conventional system to broadcast advertising content;

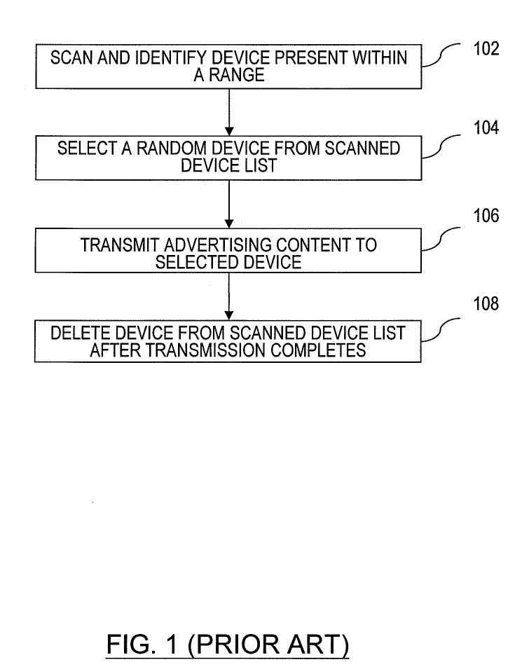

FIG. 2 illustrates a schematic diagram of a system capable of effectively managing multiple aerials that support short-range wireless technologies, according to one embodiment of the present invention;

FIG. 3 is a simplified block diagram illustrating the relationships among a local server and various aerials, according to one embodiment of the present invention;

FIG. 4 is a flow chart illustrating the method steps of placing the unique ID information into the queues of a local server by a scan aerial, according to one embodiment of the present invention;

FIG. 5 is a flow chart illustrating the method steps of a push aerial distributing data to each of the unique IDs, according to one embodiment of the present invention; and

FIG. 6 illustrates one example of utilizing time stamp information to adjust the sequence of transmitting data to an identified device, according to one embodiment of the present invention.

### DETAILED DESCRIPTION

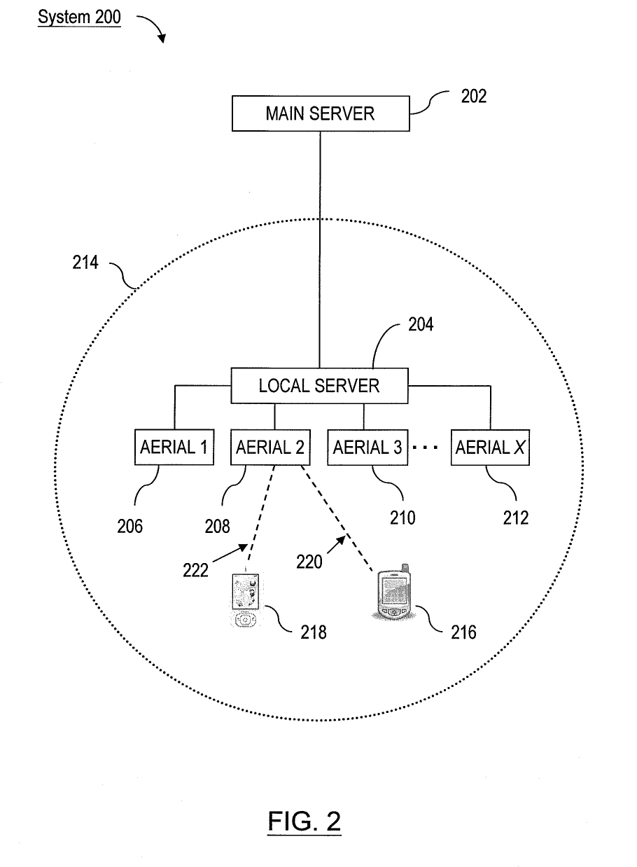

FIG. 2 illustrates a schematic diagram of a system 200 capable of effectively managing multiple aerials that support short-range wireless technologies, according to one embodiment of the present invention. In one implementation, the system includes a main server 202 and a local server 204 coupled with X number of aerials, such as a first aerial 206, a second aerial 208, and a third aerial 210. An aerial is a wireless beacon capable of transmitting wireless signal to devices within its coverage range. X here represents the number of aerials that the local server 204 is programmed to support. Each aerial operates independently and is equipped with short-range wireless technologies such as Bluetooth. The main server 202 and the local server 204 are located in different physical locations. The information collected by the aerials may be transmitted from the local server 204 to the main server 202 for additional processing. The main server 202 and the local server 204 are able to exchange information via a network connection, such as the Internet connection.

Among the X number of aerials managed by the local server 204, in one implementation, the aerials can be broadly separated into two types, a scan aerial type and a push aerial type. The scan aerial is configured to scan and identify devices, and the push aerial is configured to transmit advertising content to one or more identified devices. Detailed discussions of these two types of aerials will be further provided in the subsequent paragraphs.

In one implementation, the pre-determined coverage range 214 supported in the system 200 may be adjusted according to certain parameters, such as, without limitation, the number of aerials that the system 200 has and the locations of the aerials. When a device, such as a mobile phone 216 or a mobile phone 218, enters the pre-determined coverage range 214 with the Bluetooth function enabled, a scan aerial detects their signals and obtains their unique identification (ID) information. With this unique ID information, the local server 204 of the system 200 configures an appropriate push aerial to deliver data, such as advertising content, to the mobile phone 216 and the mobile phone 218. Alternatively, the local server 204 may also transmit the unique ID information to the main server 202 for additional processing. It is worth noting that a push aerial is capable of connecting and transmitting data to multiple devices. For example, the second aerial 208 in FIG. 2 is shown to transmit data to both the mobile phone 216 and the mobile phone 218 via a signal path 220 and a signal path 222, respectively.

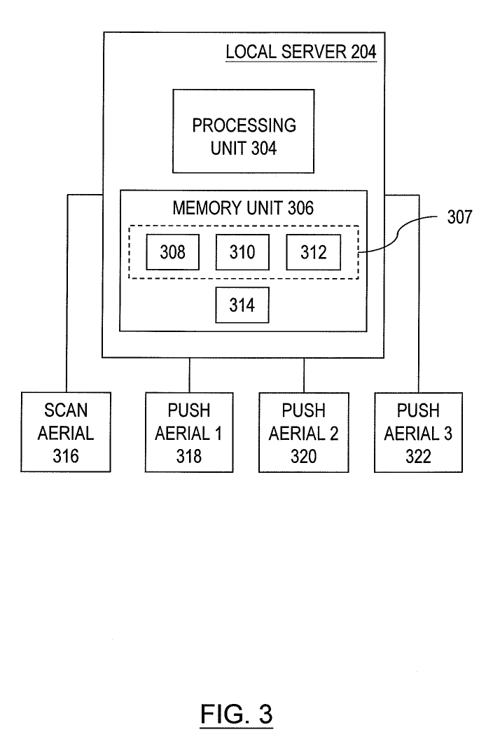

In conjunction with FIG. 2, FIG. 3 is a simplified block diagram further illustrating the relationships among the local server 204 and the various aerials, according to one embodiment of the present invention. The local server 204 includes a processing unit 304 and a memory unit 306 coupled to the processing unit 304. The multiple aerials, such as a scan aerial 316, a first push aerial 318, a second push aerial 320, and a third push aerial 322, are coupled to the local server 204. The scan aerial 316 is configured to scan within the pre-determined range coverage 214 as shown in FIG. 2 and to identify the unique ID information of the devices that are within the coverage range 214. Independently from the operations of the scan aerial 316, one of the push aerials is configured to deliver data to the identified device.

In one implementation, the local server 204 is configured to manage a first process of identifying unique ID information of various devices and a second process of delivering data to such devices in a particular sequence. The two processes can be carried out in parallel, and the execution of one process does not depend on the completion of execution of another process. The sequence of data delivery here is established based on the priority level associated with each unique ID. Specifically, the local server 204 supports a queue 307 associated with a first priority level, such as a high priority level, and a queue 314 associated with a second priority level, such as a regular priority level. If the priority level assigned to a unique ID matches the priority level of a queue, then the ID is stored in that particular queue. To establish the priority level for each of the identified IDs, the processing unit 304 is configured to rely on a set of conditions. For example, one of the conditions may be to associate a high priority level with the identified ID, if (1) the ID of the device is recognized by the local server 204 for the first time and is considered “new”, or (2) the device with the ID is recognized by the local server 204 to have successfully received data from the local server 204 in the past. On the other hand, another condition may be to associate a regular priority level with the ID, if the device with the ID is recognized by the local server to have failed to receive data from the local server 204 in the past. This failure may be attributed to, without limitation, an unstable or a poor connection between the push aerial and the device and a rejection from the device itself.

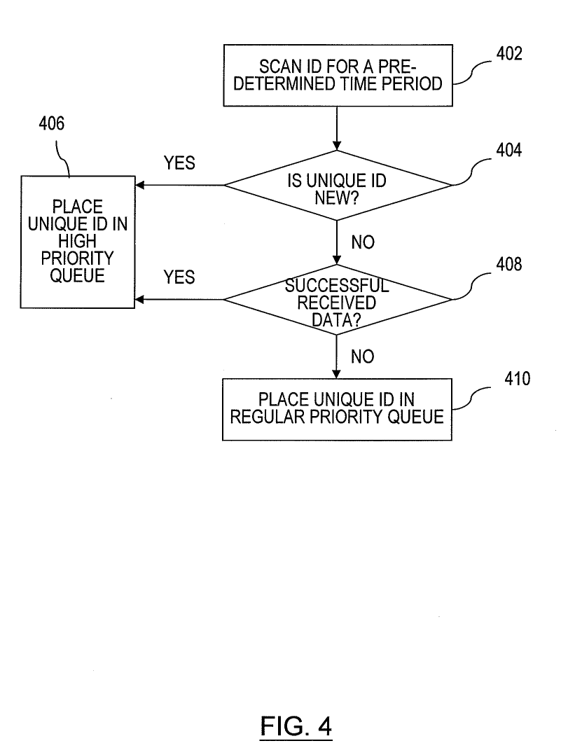

In conjunction with FIG. 3, FIG. 4 is a flow chart illustrating the method steps of placing the unique ID information into the queues of the local server 204 by the scan aerial 316, according to one embodiment of the present invention. In step 402, the scan aerial 316 scans for unique IDs within the pre-determined coverage range for a pre-determined time period. If a unique ID is detected, in step 404 the scan aerial 316 first checks if the unique ID is new to the local server 204. If the answer is yes, then the processing unit 304 associates a high priority level with the unique ID and places the ID into the high priority queue 307 in step 406. If the answer is no, then the scan aerial 316 checks if the device has successfully received data from the local server 204 in the past in step 408. If the answer is yes, then the ID uniquely identifying the device is still associated with a high priority level and is placed into the high priority queue. On the other hand, if the answer is no, then the ID is associated with a regular priority level and is placed into the regular priority queue 314 in step 410. It should be apparent to a person with ordinary skills in the art to implement the method steps illustrated in FIG. 4 and described above in other sequences without exceeding the scope of the present invention. For instance, the verification performed in step 408 can take place prior to the verification performed in step 404. With the aforementioned process, the local server 204 can efficiently identify in a relatively short period of time devices that are more likely to receive data, such as advertising content.

In one implementation, the high priority queue 307 of FIG. 3 further includes a number of temporary storage units allocated from the memory unit 306, such as the temporary storage units 308, 310, and 312 and is configured to store the IDs associated with the same high priority level. Each of the temporary storage unit corresponds to a push aerial. Suppose all the IDs of the five devices identified by the scan aerial 316 are associated with the same high priority level. In a round-robin manner, the unique ID of the first identified device is placed into the temporary storage unit 308, which corresponds to the first push aerial 318. Then, the unique ID of the second identified device is placed into the temporary storage unit 310, which corresponds to the second push aerial 320. Similarly, the unique ID of the third identified device is placed into the temporary storage unit 312, which corresponds to the third push aerial 322. As for the unique IDs of the fourth and the fifth identified devices, they are placed into the temporary storage unit 308 and the temporary storage unit 310, respectively. In this implementation, the scan aerial 316 distributes the unique ID information evenly among the temporary storage units in the high priority queue 307 and in effect evenly distributes the workload among the push aerials.

However, if one of the devices identified by the scan aerial 316 is associated with a regular priority level, the unique ID of this device is placed into the regular priority queue 314. Due to this regular priority level, the ID stored in the regular priority queue 314 is processed after the processing of all the IDs in the high priority queue 307. Although FIG. 3 illustrates a certain number of aerials, temporary storage units, and queues, it is for the sole purpose of demonstrating one example of associating each identified ID with certain priority information and shall not be considered to limit the scope of the present invention.

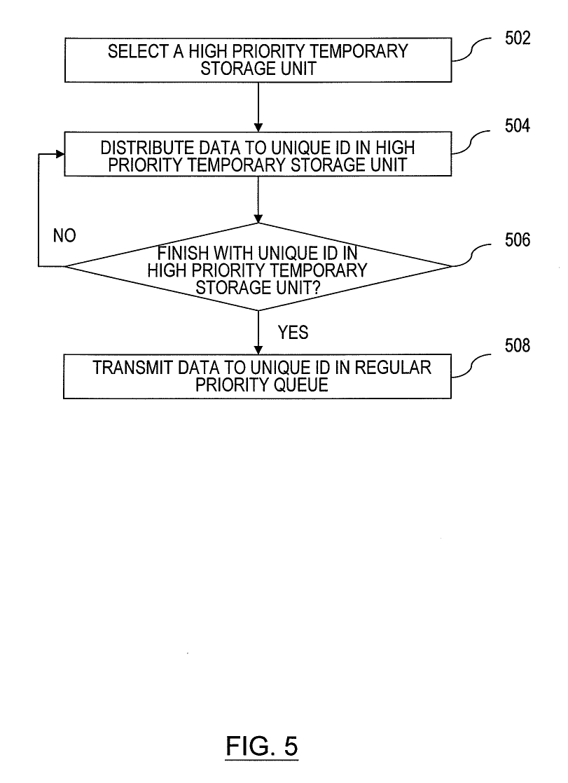

FIG. 5 is a flow chart illustrating the method steps of a push aerial distributing data, such as advertising content, to each of the unique IDs, according to one embodiment of the present invention. In conjunction with FIG. 3, in step 502, the local server 204 selects one of the temporary storage units in the high priority queue 307. In step 504, data, such as advertising content, is distributed to the unique ID stored in such a temporary storage unit. In one implementation, as discussed above, each of the high priority temporary storage unit is associated with a push aerial, and each push aerial can independently send data to the devices with the unique IDs stored in such temporary storage units. Because each push aerial may distribute data to multiple devices in parallel, to avoid having multiple aerials attempting to deliver data to the same device at the same time, a lock mechanism may be employed. In other words, if a push aerial gains access to a device, then this device is considered “locked,” or in other words, inaccessible by other push aerials. If, however, the data delivery to the device fails, then the device may be unlocked, and the unique ID of this device is placed into the regular priority queue 314 to be processed after the processing of all the other unique IDs in the high priority queue 307 is completed.

In step 506, the local server 204 checks whether each push aerial finishes distributing data to the devices with the unique IDs in the corresponding temporary storage unit. If the answer is no, the process returns to step 504 and processes the remaining unique IDs in the temporary storage unit. If the answer is yes, then one of the push aerials in step 508 accesses the unique IDs stored in the regular priority queue 314 and distributes data to all the unique IDs in the queue. It should be noted that as the push aerial accesses the regular priority queue 314, one unique ID is accessed at a time.

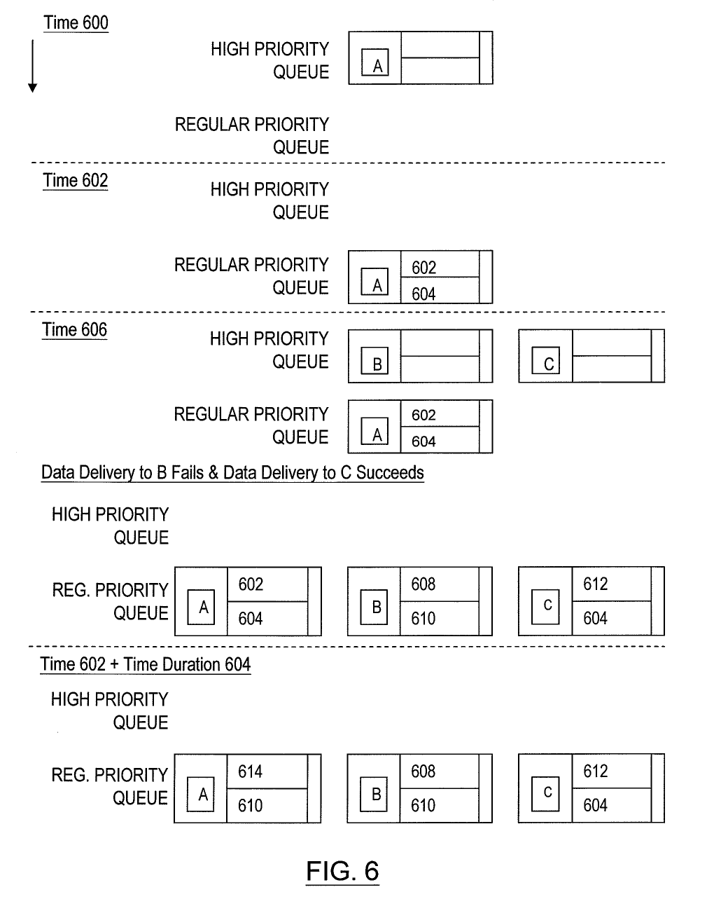

In an alternative implementation, in addition to associating each identified ID with certain priority information, the identified ID is also associated with certain time stamp information, which is utilized to further adjust the sequence of processing the identified ID. FIG. 6 illustrates one example of utilizing such time stamp information, according to one embodiment of the present invention. In conjunction with FIG. 3 and similar to the discussions above, one of the conditions to associate an ID uniquely identifying a detected device with the high priority level is if the device is new to the local server 204. Suppose a device with the ID A is detected by the scan aerial 316 and is new to the local server 204. At time 600, the ID A is placed in the high priority queue 307. At time 602, suppose one of the push aerials successfully delivers data to the device, and the time 602 is 10:50. The ID A, along with the time stamp of 10:50 and also time duration 604, is stored in the regular priority queue 314. The time duration 604 is used to establish the time to make the next data delivery to the device. So, suppose the time duration 604 is set to 10 minutes. The local server 204 then configures one of the push aerials to deliver data at (10:50+10), or 11. Before reaching the time 602 plus the time duration 604, or 11, at time 606, suppose devices with the ID B and ID C are detected by the scan aerial 316 and are new to the local server 204. The ID B and the ID C are placed in the high priority queue 307. In other words, the local server 204 is configured to cause data to be delivered to the devices with the ID B and the ID C before delivering to the device with the ID A.

Suppose the data delivery made to the device with the ID B fails but the data delivery made to the device with the ID C succeeds. In one implementation, due to the failure, the ID B along with time 608 and lengthened time duration 610 are stored in the regular priority queue 314. The time 608, for example, can be 10:51, and the time duration 610 can be twice as long as the time duration 604, or 20 minutes. This lengthened time duration essentially modifies the sequence of data delivery regarding the device with the ID B, because the attempt to deliver data to this device is postponed until (10:51+20), or 11:11. On the other hand, the ID C along with time 612 and the same time duration 604 are stored in the regular priority queue 314. Here, as an example, the time 612 is 10:52. In other words, the device with the ID C is thus scheduled to receive data ahead of the device with the ID B.

When the time 602 plus the time duration 604 is reached, or 11 here, suppose the data delivery made to the device with the ID A fails. Similar to the discussions above, the ID A along with time 614 and the lengthened time duration 610 are stored in the regular priority queue 314. Here, the time 614 can be 11. So, the attempt to send data to the device with the ID A is postponed to 11:20, again adjusting the sequence of data delivery to the devices with the IDs in the regular priority queue 314.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, DVD disks readable by a DVD driver, ROM chips or any type of solid-state non-volatile semiconductor memory) on which information is permanently stored; and (ii) writable storage media (e.g., floppy disks within a diskette drive, hard-disk drive, CD-RW, DVD-RW, solid-state drive, flash memory, or any type of random-access memory) on which alterable information is stored. Such computer-readable storage media, when carrying computer-readable instructions that direct the functions of the present invention, are embodiments of the present invention. Therefore, the above examples, embodiments, and drawings should not be deemed to be the only embodiments, and are presented to illustrate the flexibility and advantages of the present invention as defined by the following claims.

We claim:

1. A method for managing multiple aerials in a wireless system, the method comprises:
obtaining a first unique ID of a first device within a coverage range, associating a first priority level to the first unique ID, and storing the first unique ID in a first queue associated with the first priority level in a first process; and
independently from the first process, transmitting data to the first device with the first unique ID in a sequence based on at least the first priority level in a second process.

2. The method of claim 1, further comprising setting the first priority level to a high priority, if the first unique ID is detected within the coverage range prior to executing the first process.

3. The method of claim 1, further comprising setting the first priority level to a high priority, if the first device has successfully received data prior to executing the first process.

4. The method of claim 2, wherein the sequence dictates transmitting data to the first device with the first unique ID prior to transmitting data to a second device with a second unique ID stored in a second queue associated with a second priority level, wherein the first priority level represents a higher priority than the second priority level.

5. The method of claim 4, wherein the first queue further includes a temporary storage unit that a push aerial directly accesses.

6. The method of claim 4, further comprising associating the first unique ID with a time stamp and a time duration, wherein a sum of the time stamp and the time duration indicates a time to transmit data to the first device with the first unique ID.

7. The method of claim 6, further comprising storing the first unique ID with the time stamp and the time duration in the second queue.

8. The method of claim 7, further comprising lengthening the time duration before the storing step, if the first device fails to receive data.

9. The method of claim 1, wherein the wireless system supports a Bluetooth protocol.

10. A device for managing at least a scan aerial and a push aerial in a wireless system, the device comprises:
a memory unit configured to support a first queue and a second queue; and
a processing unit configured to
obtain a first unique ID of a first device within a coverage range of the scan aerial, associate a first priority level to the first unique ID, and store the first unique ID in the first queue associated with the first priority level in a first process, and
independently from the first process, cause data to be transmitted via the push aerial to the first device with the first unique ID in a sequence based on at least the first priority level in a second process.

11. The device of claim 10, wherein the processing unit is further configured to set the first priority level to a high priority, if the first unique ID is recognized by the processing unit prior to executing the first process.

12. The device of claim 10, wherein the processing unit is further configured to set the first priority level to a high priority, if the first device is recognized by the processing unit to have successfully received data from the device prior to executing the first process.

13. The device of claim 11, wherein the processing unit is further configured to adhere to the sequence of transmitting data to the first device with the first unique ID prior to transmitting data to a second device with a second unique ID stored in the second queue associated with a second priority level, wherein the first priority level represents a higher priority than the second priority level.

14. The device of claim 13, wherein the first queue further includes a temporary storage unit that the push aerial directly accesses.

15. The device of claim 13, wherein the processing unit is further configured to associate the first unique ID with a time stamp and a time duration, wherein a sum of the time stamp and the time duration indicates a time to transmit data to the first device with the first unique ID.

16. The device of claim 15, wherein the processing unit is further configured to store the first unique ID with the time stamp and the time duration in the second queue.

17. The device of claim 16, wherein the processing unit is further configured to lengthen the time duration before the first unique ID, the time stamp, and the time duration are stored, if the first device fails to receive data from the push aerial.

18. The device of claim 10, wherein the wireless system supports a Bluetooth protocol.

19. A computer-readable medium containing a sequence of instructions, which when executed by a device configured to manage multiple aerials in a wireless system, causes the device to:
obtain a first unique ID of a first device within a coverage range, associate a first priority level to the first unique ID, and store the first unique ID in a first queue associated with the first priority level in a first process; and
independently from the first process, cause data to be transmitted to the first device with the first unique ID in a sequence based on at least the first priority level in a second process.

20. The computer-readable medium of claim 19, further containing a sequence of instructions, which when executed by the device, causes the device to set the first priority level to a high priority, if the first unique ID is recognized by the device prior to executing the first process.

21. The computer-readable medium of claim 20, further containing a sequence of instructions, which when executed by the device, causes the device to adhere to the sequence of transmitting data to the first device with the first unique ID prior to transmitting data to a second device with a second unique ID stored in the second queue associated with a second priority level, wherein the first priority level represents a higher priority than the second priority level.

22. The computer-readable medium of claim 21, further containing a sequence of instructions, which when executed by the device, causes the device to associate the first unique ID with a time stamp and a time duration, wherein a sum of the time stamp and the time duration indicates a time to transmit data to the first device with the first unique ID.

23. The computer-readable medium of claim 22, further containing a sequence of instructions, which when executed by the device, causes the device to store the first unique ID with the time stamp and the time duration in the second queue.

24. The computer-readable medium of claim 23, further containing a sequence of instructions, which when executed by the device, causes the device to lengthen the time duration before the first unique ID, the time stamp, and the time duration are stored, if the first device fails to receive data.

25. The computer-readable medium of claim 19, wherein the wireless system supports a Bluetooth protocol.
